(19) United States
(12) Patent Application Publication
(10) Pub. No.: US 2016/0282972 A1
(43) Pub. Date: Sep. 29, 2016

(54) METAL MESH TOUCH SENSOR WITH RANDOMIZED PITCH

(71) Applicant: Uni-Pixel Displays, Inc., The Woodlands, TX (US)

(72) Inventors: Hong Shu, The Woodlands, TX (US); James Steve Posenjak, Conroe, TX (US); Kenneth B. Frame, Spring, TX (US); Francisco D. Saldana, Houston, TX (US); Mark Wendt, Houston, TX (US); Larry C. Dodson, The Woodlands, TX (US); Kenny Huy Pham, Spring, TX (US)

(21) Appl. No.: 14/680,763

(22) Filed: Apr. 7, 2015

Related U.S. Application Data
(60) Provisional application No. 62/137,780, filed on Mar. 24, 2015.

(51) Int. Cl. G06F 3/041; G06F 17/50; G06F 3/044

(52) U.S. Cl. CPC G06F 3/041; G06F 3/044; G06F 17/50; G06F 2203/04112; G06F 2203/04103

(57) ABSTRACT

A method of designing a metal mesh touch sensor with randomized pitch includes placing a first plurality of representations of parallel conductive lines oriented in a first direction with fixed pitch spacing between adjacent representations of parallel conductive lines oriented in the first direction. For each placed representation of a parallel conductive line in the first plurality of representations of parallel conductive lines oriented in the first direction, a first random offset amount within a predetermined randomization constraint is generated. The placed representation of the parallel conductive line is moved by the first random offset.

### CROSS-REFERENCE TO RELATED APPLICATIONS

This application claims the benefit of, or priority to, U.S. Provisional Patent Application Ser. No. 62/137,780, filed on Mar. 24, 2015, which is hereby incorporated by reference in its entirety.

### BACKGROUND OF THE INVENTION

A touch screen enabled system allows a user to control various aspects of the system by touch or gestures on the screen. A user may interact directly with one or more objects depicted on a display device by touch or gestures that are sensed by a touch sensor. The touch sensor typically includes a conductive pattern disposed on a substrate configured to sense touch. Touch screens are commonly used in consumer, commercial, and industrial systems.

### BRIEF SUMMARY OF THE INVENTION

According to one aspect of one or more embodiments of the present invention, a method of designing a metal mesh touch sensor with randomized pitch includes placing a first plurality of representations of parallel conductive lines oriented in a first direction with fixed pitch spacing between adjacent representations of parallel conductive lines oriented in the first direction. For each placed representation of a parallel conductive line in the first plurality of representations of parallel conductive lines oriented in the first direction, a first random offset amount within a predetermined randomization constraint is generated. The placed representation of the parallel conductive line is moved by the first random offset. The method also includes placing a first plurality of representations of parallel conductive lines oriented in a second direction with fixed pitch spacing between adjacent representations of parallel conductive lines oriented in the second direction. For each placed representation of a parallel conductive line in the first plurality of representations of parallel conductive lines oriented in the second direction, a second random offset amount within the predetermined randomization constraint is generated. The placed representation of the parallel conductive line is moved by the second random offset.

According to one aspect of one or more embodiments of the present invention, a metal mesh touch sensor with randomized pitch includes a transparent substrate, a first conductive pattern disposed on a first side of the transparent substrate, and a second conductive pattern disposed on a second side of the transparent substrate. The first conductive pattern includes a first plurality of parallel conductive lines oriented in a first direction with randomized pitch spacing between adjacent parallel conductive lines oriented in the first direction and a first plurality of parallel conductive lines oriented in a second direction with randomized pitch spacing between adjacent parallel conductive lines oriented in the second direction. The second conductive pattern includes a second plurality of parallel conductive lines oriented in the first direction with randomized pitch spacing between adjacent parallel conductive lines oriented in the first direction and a second plurality of parallel conductive lines oriented in the second direction with randomized pitch spacing between adjacent parallel conductive lines oriented in the second direction.

According to one aspect of one or more embodiments of the present invention, a metal mesh touch sensor with randomized pitch includes a first transparent substrate, a first conductive pattern disposed on a side of the first transparent substrate, a second transparent substrate, and a second conductive pattern disposed on a side of the second transparent substrate. The first transparent substrate is bonded to the second transparent substrate. The first conductive pattern includes a first plurality of parallel conductive lines oriented in a first direction with randomized pitch spacing between adjacent parallel conductive lines oriented in the first direction and a first plurality of parallel conductive lines oriented in a second direction with randomized pitch spacing between adjacent parallel conductive lines oriented in the second direction. The second conductive pattern includes a second plurality of parallel conductive lines oriented in the first direction with randomized pitch spacing between adjacent parallel conductive lines oriented in the first direction and a second plurality of parallel conductive lines oriented in the second direction with randomized pitch spacing between adjacent parallel conductive lines oriented in the second direction.

Other aspects of the present invention will be apparent from the following description and claims.

### BRIEF DESCRIPTION OF THE DRAWINGS

FIG. 1 shows a cross section of a touch screen in accordance with one or more embodiments of the present invention.

FIG. 2 shows a schematic view of a touch screen enabled system in accordance with one or more embodiments of the present invention.

FIG. 3 shows a functional representation of a touch sensor as part of a touch screen in accordance with one or more embodiments of the present invention.

FIG. 4 shows a cross-section of a touch sensor with conductive patterns disposed on opposing sides of a transparent substrate in accordance with one or more embodiments of the present invention.

FIG. 5A shows a first conductive pattern disposed on a transparent substrate in accordance with one or more embodiments of the present invention.

FIG. 5B shows a second conductive pattern disposed on a transparent substrate in accordance with one or more embodiments of the present invention.

FIG. 5C shows a mesh area of a metal mesh touch sensor in accordance with one or more embodiments of the present invention.

FIG. 6A shows a portion of a first plurality of representations of parallel conductive lines oriented in a second direction of a representation of a first conductive pattern in accordance with one or more embodiments of the present invention.

FIG. 6B shows a portion of a first plurality of representations of parallel conductive lines oriented in a first direction of a representation of a first conductive pattern in accordance with one or more embodiments of the present invention.

FIG. 6C shows a portion of a second plurality of representations of parallel conductive lines oriented in a second direction of a representation of a second conductive pattern in accordance with one or more embodiments of the present invention.

FIG. 6D shows a portion of a second plurality of representations of parallel conductive lines oriented in a first direction of a representation of a second conductive pattern in accordance with one or more embodiments of the present invention.

FIG. 6E shows a portion of a metal mesh touch sensor in accordance with one or more embodiments of the present invention.

FIG. 7A shows a portion of a plurality of representations of parallel conductive lines oriented in a second direction of a representation of a first conductive pattern with randomized pitch in accordance with one or more embodiments of the present invention.

FIG. 7B shows a portion of a plurality of representations of parallel conductive lines oriented in a first direction of a representation of a first conductive pattern with randomized pitch in accordance with one or more embodiments of the present invention.

FIG. 7C shows a portion of a plurality of representations of parallel conductive lines oriented in a second direction of a representation of a second conductive pattern with randomized pitch in accordance with one or more embodiments of the present invention.

FIG. 7D shows a portion of a plurality of representations of parallel conductive lines oriented in a first direction of a representation of a second conductive pattern with randomized pitch in accordance with one or more embodiments of the present invention.

FIG. 7E shows a portion metal mesh touch sensor with randomized pitch in accordance with one or more embodiments of the present invention.

### DETAILED DESCRIPTION OF THE INVENTION

One or more embodiments of the present invention are described in detail with reference to the accompanying figures. For consistency, like elements in the various figures are denoted by like reference numerals. In the following detailed description of the present invention, specific details are set forth in order to provide a thorough understanding of the present invention. In other instances, well-known features to one of ordinary skill in the art are not described to avoid obscuring the description of the present invention.

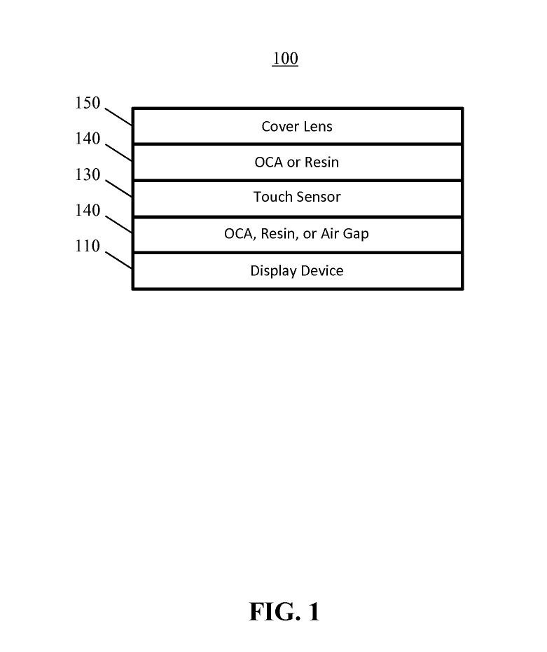

FIG. 1 shows a cross-section of a touch screen 100 in accordance with one or more embodiments of the present invention. Touch screen 100 includes a display device 110 and a touch sensor 130 that overlays at least a portion of a viewable area of display device 110. In certain embodiments, an optically clear adhesive (“OCA”) or resin 140 may bond a bottom side of touch sensor 130 to a top, or user-facing, side of display device 110. In other embodiments, an isolation layer or air gap 140 may separate the bottom side of touch sensor 130 from the top, or user-facing, side of display device 110. A transparent cover lens 150 may overlay a top, or user-facing, side of touch sensor 130. The transparent cover lens 150 may be composed of polyester, glass, or any other material suitable for use as a cover lens 150. In certain embodiments, an OCA or resin 140 may bond a bottom side of the transparent cover lens 150 to the top, or user-facing, side of touch sensor 130. A top side of transparent cover lens 150 faces the user and protects the underlying components of touch screen 100. One of ordinary skill in the art will recognize that the components and/or the stack up of touch screen 100 may vary based on an application or design in accordance with one or more embodiments of the present invention. One of ordinary skill in the art will recognize that touch sensor 130, or the function that it implements, may be integrated into the display device 110 stack up (not independently illustrated) in accordance with one or more embodiments of the present invention.

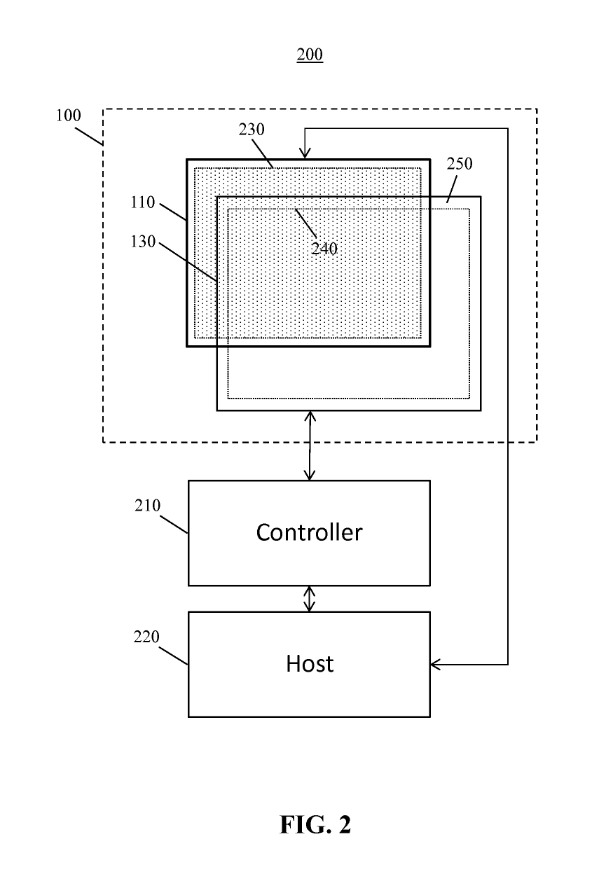

FIG. 2 shows a schematic view of a touch screen enabled system 200 in accordance with one or more embodiments of the present invention. Touch screen enabled system 200 may be a consumer, commercial, or industrial system including, but not limited to, a smartphone, tablet computer, laptop computer, desktop computer, server computer, printer, monitor, television, appliance, application specific device, kiosk, automatic teller machine, copier, desktop phone, automotive display system, portable gaming device, gaming console, or other application or design suitable for use with touch screen 100.

Touch screen enabled system 200 may include one or more printed circuit boards (not shown) or flexible circuits (not shown) on which one or more processors (not shown), system memory (not shown), and other system components (not shown) may be disposed. Each of the one or more processors may be a single-core processor (not shown) or a multi-core processor (not shown) capable of executing software instructions. Multi-core processors typically include a plurality of processor cores disposed on the same physical die (not shown) or a plurality of processor cores disposed on multiple die (not shown) disposed within the same mechanical package (not shown). System 200 may include one or more input/output devices (not shown), one or more local storage devices (not shown) including a solid-state drive, a solid-state drive array, a fixed disk drive, a fixed disk drive array, or any other non-transitory computer readable medium, a network interface device (not shown), and/or one or more network storage devices (not shown) including a network-attached storage device or a cloud-based storage device.

In certain embodiments, touch screen 100 may include touch sensor 130 that overlays at least a portion of a viewable area 230 of display device 110. Touch sensor 130 may include a viewable area 240 that corresponds to that portion of the touch sensor 130 that overlays the light emitting pixels (not shown) of display device 110 (e.g., viewable area 230 of display device 110). Touch sensor 130 may include a bezel circuit area 250 outside at least one side of the viewable area 240 of touch sensor 130 that provides connectivity (not independently illustrated) between touch sensor 130 and a controller 210. In other embodiments, touch sensor 130, or the function that it implements, may be integrated into display device 110 (not independently illustrated). Controller 210 electrically drives at least a portion of touch sensor 130. Touch sensor 130 senses touch (capacitance, resistance, optical, acoustic, or other technology) and conveys information corresponding to the sensed touch to controller 210.

The manner in which the sensing of touch is measured, tuned, and/or filtered may be configured by controller 210. In addition, controller 210 may recognize one or more gestures based on the sensed touch or touches. Controller 210 provides host 220 with touch or gesture information corresponding to the sensed touch or touches. Host 220 may use this touch or gesture information as user input and the system 200 may respond in an appropriate manner. In this way, the user may interact with touch screen enabled system 200 by touch or gestures on touch screen 100. In certain embodiments, host 220 may be the one or more printed circuit boards (not shown) or flexible circuits (not shown) on which the one or more processors (not shown) are disposed. In other embodiments, host 220 may be a subsystem (not shown) or any other part of system 200 (not shown) that is configured to interface with display device 110 and controller 210. One of ordinary skill in the art will recognize that the components and the configuration of the components of touch screen enabled system 200 may vary based on an application or design in accordance with one or more embodiments of the present invention.

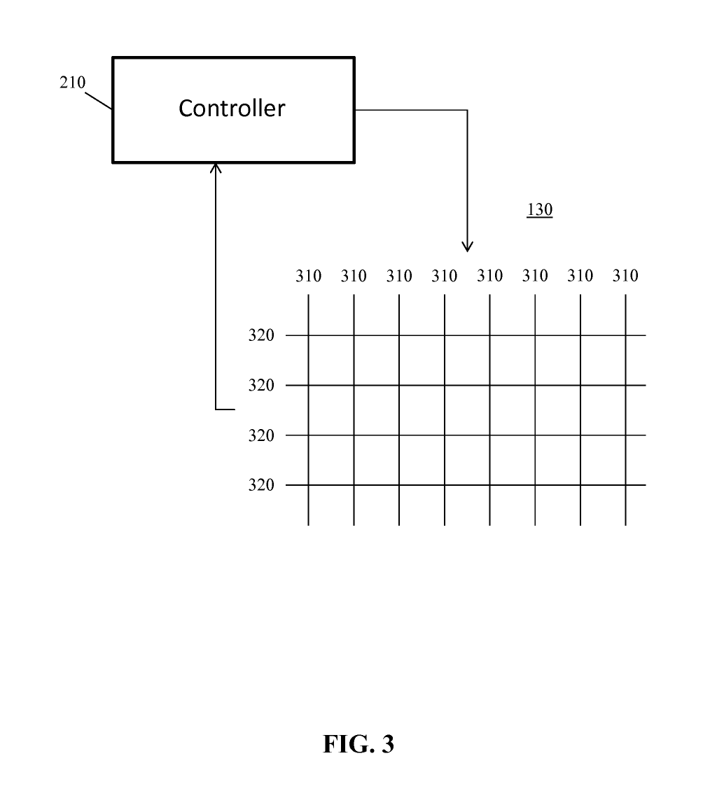

FIG. 3 shows a functional representation of a touch sensor 130 as part of a touch screen 100 in accordance with one or more embodiments of the present invention. In certain embodiments, touch sensor 130 may be viewed as a plurality of column channels 310 and a plurality of row channels 320. The plurality of column channels 310 and the plurality of row channels 320 may be separated from one another by, for example, a dielectric or substrate (not shown) on which they may be disposed. The number of column channels 310 and the number of row channels 320 may or may not be the same and may vary based on an application or a design. The apparent intersections of column channels 310 and row channels 320 may be viewed as uniquely addressable locations of touch sensor 130. In operation, controller 210 may electrically drive one or more row channels 320 and touch sensor 130 may sense touch on one or more column channels 310 that are sampled by controller 210. One of ordinary skill in the art will recognize that the role of row channels 320 and column channels 310 may be reversed such that controller 210 electrically drives one or more column channels 310 and touch sensor 130 senses touch on one or more row channels 320 that are sampled by controller 210.

In certain embodiments, controller 210 may interface with touch sensor 130 by a scanning process. In such an embodiment, controller 210 may electrically drive a selected row channel 320 (or column channel 310) and sample all column channels 310 (or row channels 320) that intersect the selected row channel 320 (or the selected column channel 310) by sensing, for example, changes in capacitance. The change in capacitance may be used to determine the location of the touch or touches. This process may be continued through all row channels 320 (or all column channels 310) such that changes in capacitance are measured at each uniquely addressable location of touch sensor 130 at predetermined intervals. Controller 210 may allow for the adjustment of the scan rate depending on the needs of a particular application or design. In other embodiments, controller 210 may interface with touch sensor 130 by an interrupt driven process. In such an embodiment, a touch or a gesture generates an interrupt to controller 210 that triggers controller 210 to read one or more of its own registers that store sensed touch information sampled from touch sensor 130 at predetermined intervals. One of ordinary skill in the art will recognize that the mechanism by which touch or gestures are sensed by touch sensor 130 and sampled by controller 210 may vary based on an application or a design in accordance with one or more embodiments of the present invention.

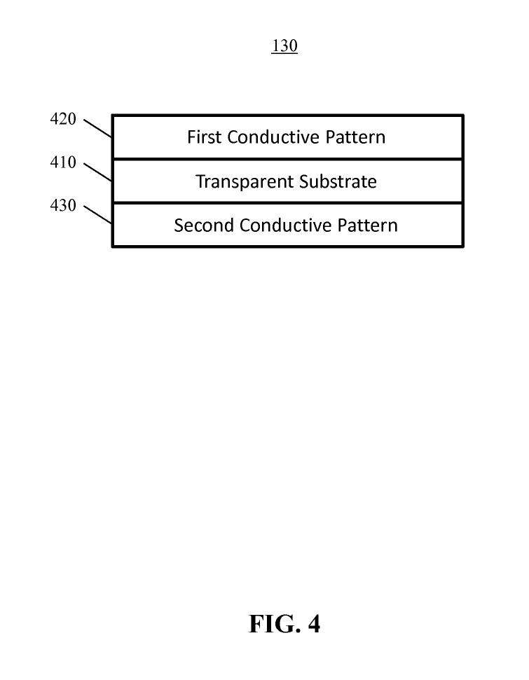

FIG. 4 shows a cross-section of a touch sensor 130 with conductive patterns 420 and 430 disposed on opposing sides of a transparent substrate 410 in accordance with one or more embodiments of the present invention. In certain embodiments, touch sensor 130 may include a first conductive pattern 420 disposed on a top, or user-facing, side of a transparent substrate 410 and a second conductive pattern 430 disposed on a bottom side of the transparent substrate 410. The first conductive pattern 420 and the second conductive pattern 430 may include different, substantially similar, or identical patterns of conductors depending on the application or design. The first conductive pattern 420 may overlay the second conductive pattern 430 at a predetermined alignment that may include an offset. One of ordinary skill in the art will recognize that a conductive pattern may be any shape or pattern of one or more conductors (not shown) in accordance with one or more embodiments of the present invention. One of ordinary skill in the art will also recognize that any type of touch sensor 130 conductor, including, for example, metal conductors, metal mesh conductors, indium tin oxide (“ITO”) conductors, poly(3,4-ethylenedioxythiophene (“PEDOT”) conductors, carbon nanotube conductors, silver nanowire conductors, or any other conductors may be used in accordance with one or more embodiments of the present invention. However, one of ordinary skill in the art will recognize that non-transparent conductors, such as those used in metal mesh touch sensors, are prone to problematic Moiré interference.

One of ordinary skill in the art will recognize that other touch sensor 130 stack ups (not shown) may be used in accordance with one or more embodiments of the present invention. For example, single-sided touch sensor 130 stack ups may include conductors disposed on a single side of a substrate 410 where conductors that cross are isolated from one another by a dielectric material (not shown), such as, for example, as used in On Glass Solution (“OGS”) touch sensor 130 embodiments. Double-sided touch sensor 130 stack ups may include conductors disposed on opposing sides of the same substrate 140 (as shown in FIG. 4) or bonded touch sensor 130 embodiments (not shown) where conductors are disposed on at least two different sides of at least two different substrates 410. Bonded touch sensor 130 stack ups may include, for example, two single-sided substrates 410 bonded together (not shown), one double-sided substrate 410 bonded to a single-sided substrate 410 (not shown), or a double-sided substrate 410 bonded to another double-sided substrate 410 (not shown). One of ordinary skill in the art will recognize that other touch sensor 130 stack ups, including those that vary in the number, type, organization, and/or configuration of substrate(s) and/or conductive pattern(s) are within the scope of one or more embodiments of the present invention. One of ordinary skill in the art will also recognize that one or more of the above-noted touch sensor 130 stack ups may be used in applications where touch sensor 130 is integrated into display device 110 in accordance with one or more embodiments of the present invention.

A conductive pattern 420 or 430 may be disposed on one or more transparent substrates 410 by any process suitable for disposing conductive lines or features on a substrate. Suitable processes may include, for example, printing processes, vacuum-based deposition processes, solution coating processes, or cure/etch processes that either form conductive lines or features on substrate or form seed lines or features on substrate that may be further processed to form conductive lines or features on substrate. Printing processes may include flexographic printing, including the flexographic printing of a catalytic ink that may be metallized by an electroless plating process to plate a metal on top of the printed catalytic ink or direct flexographic printing of conductive ink or other materials capable of being flexographically printed, gravure printing, inkjet printing, rotary printing, or stamp printing. Deposition processes may include pattern-based deposition, chemical vapor deposition, electro deposition, epitaxy, physical vapor deposition, or casting. Cure/etch processes may include optical or UV-based photolithography, e-beam/ion-beam lithography, x-ray lithography, interference lithography, scanning probe lithography, imprint lithography, or magneto lithography. One of ordinary skill in the art will recognize that any process or combination of processes, suitable for disposing conductive lines or features on substrate, may be used in accordance with one or more embodiments of the present invention.

With respect to transparent substrate 410, transparent means capable of transmitting a substantial portion of visible light through the substrate suitable for a given touch sensor application or design. In typical touch sensor applications, transparent means transmittance of at least 85% of incident visible light through the substrate. However, one of ordinary skill in the art will recognize that other transmittance values may be desirable for other touch sensor applications or designs. In certain embodiments, transparent substrate 410 may be polyethylene terephthalate (“PET”), polyethylene naphthalate (“PEN”), cellulose acetate (“TAC”), cycloaliphatic hydrocarbons (“COP”), polymethylmethacrylates (“PMMA”), polyimide (“PI”), bi-axially-oriented polypropylene (“BOPP”), polyester, polycarbonate, glass, copolymers, blends, or combinations thereof. In other embodiments, transparent substrate 410 may be any other transparent material suitable for use as a touch sensor substrate. One of ordinary skill in the art will recognize that the composition of transparent substrate 410 may vary based on an application or design in accordance with one or more embodiments of the present invention.

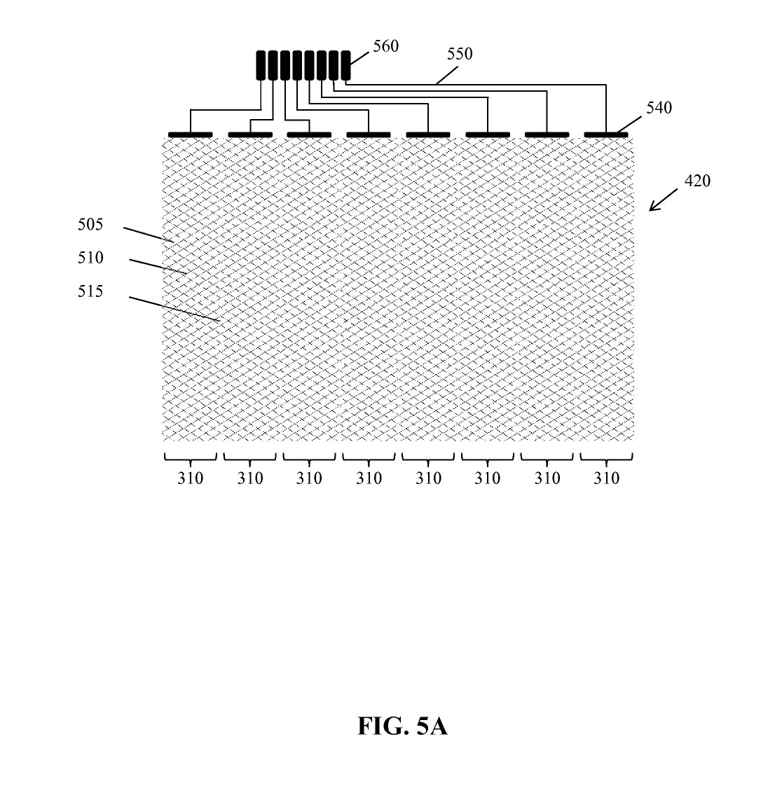

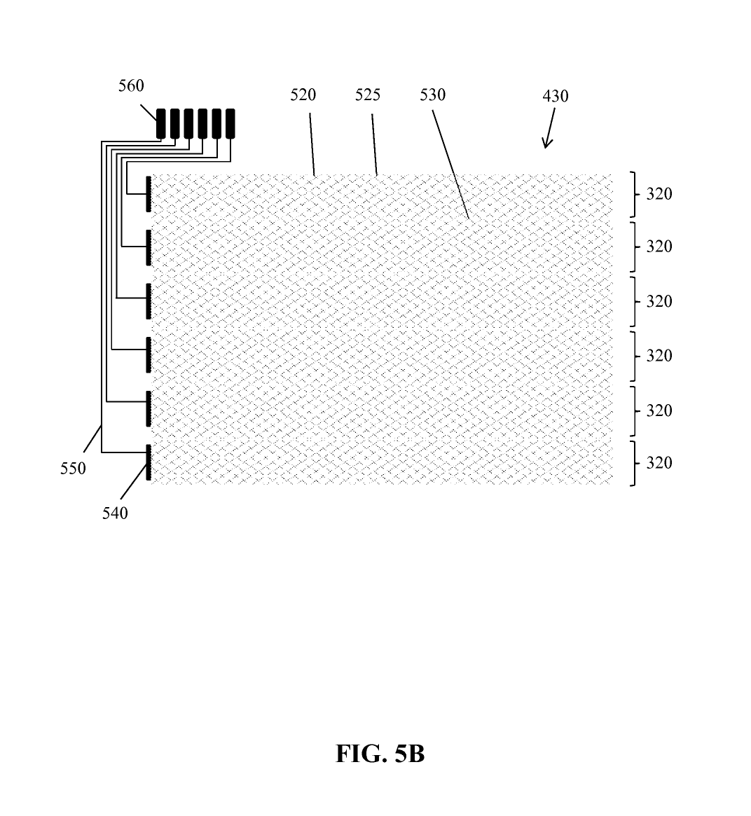

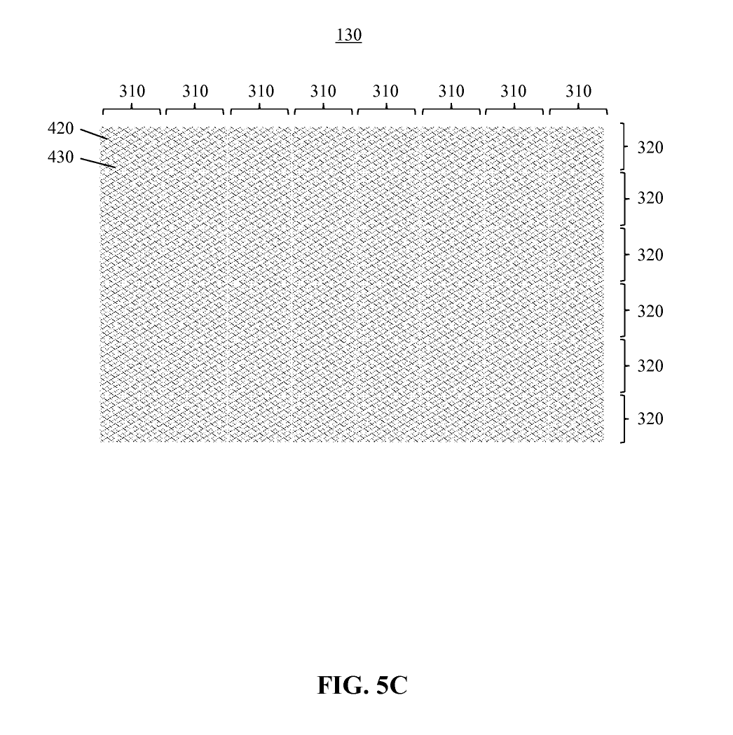

FIG. 5A shows a first conductive pattern 420 disposed on a transparent substrate (e.g., transparent substrate 410) in accordance with one or more embodiments of the present invention. In certain embodiments, first conductive pattern 420 may include a mesh formed by a first plurality of parallel conductive lines oriented in a first direction 505 and a first plurality of parallel conductive lines oriented in a second direction 510 that are disposed on a side of a transparent substrate (e.g., transparent substrate 410). One of ordinary skill in the art will recognize that the number of parallel conductive lines oriented in the first direction 505 and/or the number of parallel conductive lines oriented in the second direction 510 may or may not be the same and may vary based on an application or design. One of ordinary skill in the art will also recognize that a size of first conductive pattern 420 may vary based on an application or a design. In other embodiments, first conductive pattern 420 may include any other shape or pattern formed by one or more conductive lines or features (not independently illustrated). One of ordinary skill in the art will recognize that first conductive pattern 420 is not limited to parallel conductive lines and may comprise any one or more of a predetermined orientation of line segments, a random orientation of line segments, curved line segments, conductive particles, polygons, or any other shape(s) or pattern(s) comprised of electrically conductive material (not independently illustrated) in accordance with one or more embodiments of the present invention.

In certain embodiments, the first plurality of parallel conductive lines oriented in the first direction 505 may be perpendicular to the first plurality of parallel conductive lines oriented in the second direction 510, thereby forming a rectangle-type mesh. In other embodiments, the first plurality of parallel conductive lines oriented in the first direction 505 may be angled (not shown) relative to the first plurality of parallel conductive lines oriented in the second direction 510, thereby forming a parallelogram-type mesh. One of ordinary skill in the art will recognize that the relative angle between the first plurality of parallel conductive lines oriented in the first direction 505 and the first plurality of parallel conductive lines oriented in the second direction 510 may vary based on an application or a design in accordance with one or more embodiments of the present invention.

In certain embodiments, a first plurality of channel breaks 515 may partition first conductive pattern 420 into a plurality of column channels 310, each electrically isolated from the others (no electrical continuity). One of ordinary skill in the art will recognize that the number of channel breaks 515, the number of column channels 310, and/or the width of the column channels 310 may vary based on an application or design in accordance with one or more embodiments of the present invention. Each column channel 310 may route to a channel pad 540. Each channel pad 540 may route via one or more interconnect conductive lines 550 to an interface connector 560. Interface connectors 560 may provide a connection interface between a touch sensor (e.g., 130 of FIG. 2) and a controller (e.g., 210 of FIG. 2).

FIG. 5B shows a second conductive pattern 430 disposed on a transparent substrate (e.g., transparent substrate 410) in accordance with one or more embodiments of the present invention. In certain embodiments, second conductive pattern 430 may include a mesh formed by a second plurality of parallel conductive lines oriented in a first direction 520 and a second plurality of parallel conductive lines oriented in a second direction 525 that are disposed on a side of a transparent substrate (e.g., transparent substrate 410). One of ordinary skill in the art will recognize that the number of parallel conductive lines oriented in the first direction 520 and/or the number of parallel conductive lines oriented in the second direction 525 may vary based on an application or design. The second conductive pattern 430 may be substantially similar in size to the first conductive pattern 420. One of ordinary skill in the art will recognize that a size of the second conductive pattern 430 may vary based on an application or a design. In other embodiments, second conductive pattern 430 may include any other shape or pattern formed by one or more conductive lines or features (not independently illustrated). One of ordinary skill in the art will also recognize that second conductive pattern 430 is not limited to parallel conductive lines and could be any one or more of a predetermined orientation of line segments, a random orientation of line segments, curved line segments, conductive particles, polygons, or any other shape(s) or pattern(s) comprised of electrically conductive material (not independently illustrated) in accordance with one or more embodiments of the present invention.

In certain embodiments, the second plurality of parallel conductive lines oriented in the first direction 520 may be perpendicular to the second plurality of parallel conductive lines oriented in the second direction 525, thereby forming a rectangle-type mesh. In other embodiments, the second plurality of parallel conductive lines oriented in the first direction 520 may be angled (not shown) relative to the second plurality of parallel conductive lines oriented in the second direction 525, thereby forming a parallelogram-type mesh. One of ordinary skill in the art will recognize that the relative angle between the second plurality of parallel conductive lines oriented in the first direction 520 and the second plurality of parallel conductive lines oriented in the second direction 525 may vary based on an application or a design in accordance with one or more embodiments of the present invention.

In certain embodiments, a plurality of channel breaks 530 may partition second conductive pattern 430 into a plurality of row channels 320, each electrically isolated from the others (no electrical continuity). One of ordinary skill in the art will recognize that the number of channel breaks 530, the number of row channels 320, and/or the width of the row channels 320 may vary based on an application or design in accordance with one or more embodiments of the present invention. Each row channel 320 may route to a channel pad 540. Each channel pad 540 may route via one or more interconnect conductive lines 550 to an interface connector 560. Interface connectors 560 may provide a connection interface between a touch sensor (e.g., 130 of FIG. 2) and a controller (e.g., 210 of FIG. 2).

FIG. 5C shows a mesh area of a metal mesh touch sensor 130 in accordance with one or more embodiments of the present invention. In certain embodiments, a touch sensor 130 may be formed, for example, by disposing a first conductive pattern 420 on a top, or user-facing, side of a transparent substrate (e.g., transparent substrate 410) and disposing a second conductive pattern 430 on a bottom side of the transparent substrate (e.g., transparent substrate 410). In other embodiments, a touch sensor 130 may be formed, for example, by disposing a first conductive pattern 420 on a side of a first transparent substrate (e.g., transparent substrate 410), disposing a second conductive pattern 430 on a side of a second transparent substrate (e.g., transparent substrate 410), and bonding the first transparent substrate to the second transparent substrate. One of ordinary skill in the art will recognize that the disposition of the conductive pattern or patterns may vary based on the touch sensor 130 stack up in accordance with one or more embodiments of the present invention. In embodiments that use two conductive patterns, the first conductive pattern 420 and the second conductive pattern 430 may be offset vertically, horizontally, and/or angularly relative to one another. The offset between the first conductive pattern 420 and the second conductive pattern 430 may vary based on an application or a design. One of ordinary skill in the art will recognize that the first conductive pattern 420 and the second conductive pattern 430 may be disposed on substrate or substrates 410 using any process or processes suitable for disposing the conductive patterns on the substrate or substrates 410 in accordance with one or more embodiments of the present invention.

In certain embodiments, the first conductive pattern 420 may include a first plurality of parallel conductive lines oriented in a first direction (e.g., 505 of FIG. 5A) and a first plurality of parallel conductive lines oriented in a second direction (e.g., 510 of FIG. 5A) that form a mesh that is partitioned by a first plurality of channel breaks (e.g., 515 of FIG. 5A) into electrically partitioned column channels 310. In certain embodiments, the second conductive pattern 430 may include a second plurality of parallel conductive lines oriented in a first direction (e.g., 520 of FIG. 5B) and a second plurality of parallel conductive lines oriented in a second direction (e.g., 525 of FIG. 5B) that form a mesh that is partitioned by a second plurality of channel breaks (e.g., 530 of FIG. 5B) into electrically partitioned row channels 320. In operation, a controller (e.g., 210 of FIG. 2) may electrically drive one or more row channels 320 (or column channels 310) and touch sensor 130 senses touch on one or more column channels 310 (or row channels 320). In other embodiments, the disposition and/or the role of the first conductive pattern 420 and the second conductive pattern 430 may be reversed.

In certain embodiments, one or more of the plurality of parallel conductive lines oriented in the first direction (e.g., 505 of FIG. 5A, 520 of FIG. 5B) and one or more of the plurality of parallel conductive lines oriented in the second direction (e.g., 510 of FIG. 5A, 525 of FIG. 5A) may have a line width that varies based on an application or design, including, for example, micrometer-fine line widths. In addition, the number of parallel conductive lines oriented in the first direction (e.g., 505 of FIG. 5A, 520 of FIG. 5B), the number of parallel conductive lines oriented in the second direction (e.g., 510 of FIG. 5A, 525 of FIG. 5B), and the line-to-line spacing between them may vary based on an application or a design. One of ordinary skill in the art will recognize that the size, configuration, and design of each conductive pattern 420, 430 may vary based on an application or a design in accordance with one or more embodiments of the present invention. One of ordinary skill in the art will also recognize that touch sensor 130 depicted in FIG. 5C is illustrative but not limiting and that the size, shape, and design of the touch sensor 130 is such that there is substantial transmission of an image (not shown) of an underlying display device (e.g., 110 of FIG. 1) in actual use that is not shown in the drawing.

In one or more embodiments of the present invention, a method of designing a metal mesh touch sensor with randomized pitch may be performed using existing software tools used to design a representation of a conductive pattern. A representation of a conductive pattern is a drawing of the pattern that may be generated in a software application, such as, for example, a computer-aided drafting (“CAD”) software application. The representation of the conductive pattern may be used as part of a larger process to fabricate the conductive pattern as part of the fabrication of a touch sensor. In certain embodiments, the representation of the conductive pattern may have a plurality of virtual layers that partition the representation of the conductive pattern to facilitate fabrication of the conductive pattern. For example, in certain embodiments, the representation of the conductive pattern may include a plurality of representations of parallel conductive lines oriented in a first direction on one virtual layer and a plurality of representations of parallel conductive lines oriented in a second direction on another virtual layer. In this way, the representation of the conductive pattern may be partitioned into distinct layers that correspond to a distinct number of flexographic printing plates that may be used to print a catalytic ink image of the representation of the conductive pattern on substrate.

In certain embodiments, the one or more layers of the representation of the conductive pattern may be used to form one or more thermal imaging layers. The one or more thermal imaging layers may be used to fabricate one or more flexographic printing plates used in one or more flexographic printing stations of a multi-station flexographic printing system. The one or more flexographic printing stations may be used to print a catalytic ink image of the representation of the conductive pattern, in a layer-by-layer manner, on substrate. The printed catalytic ink image of the representation of the conductive pattern may be metallized by one or more electroless plating processes or other metallization processes that metalize the printed catalytic ink image, thereby forming the conductive pattern on substrate. The conductive pattern is then capable of serving an electrical function as part of a touch sensor as discussed herein.

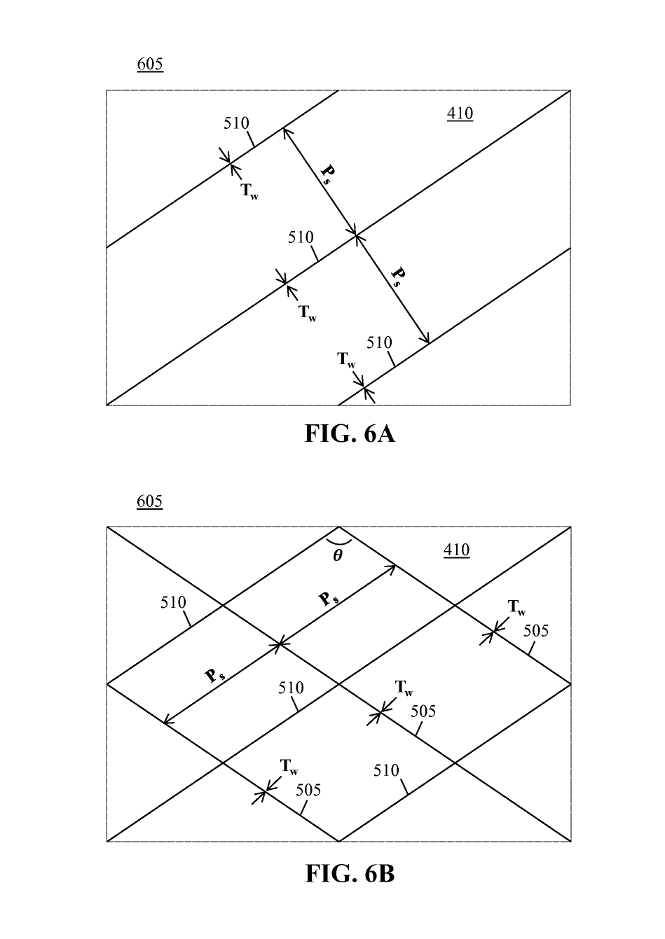

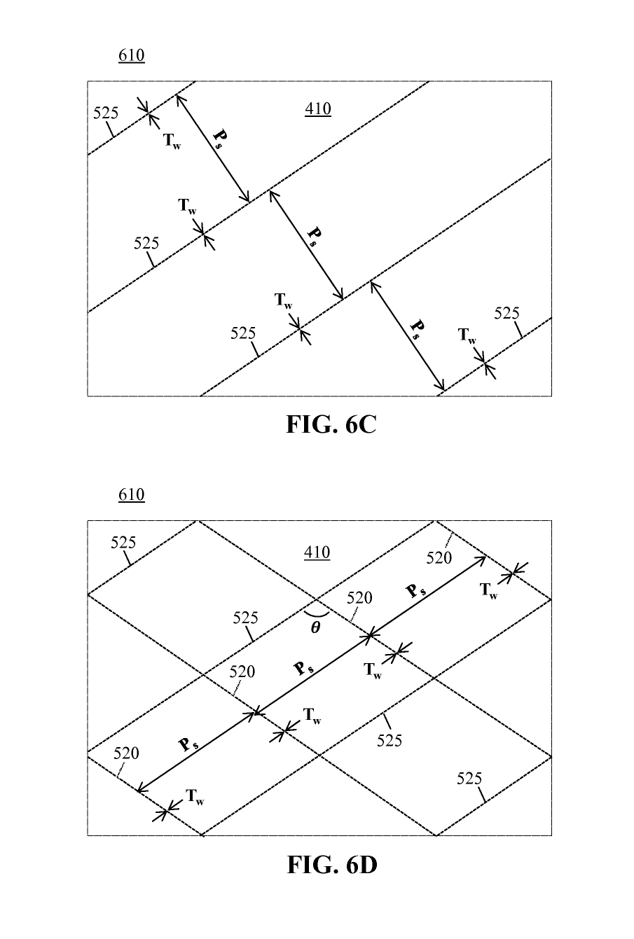

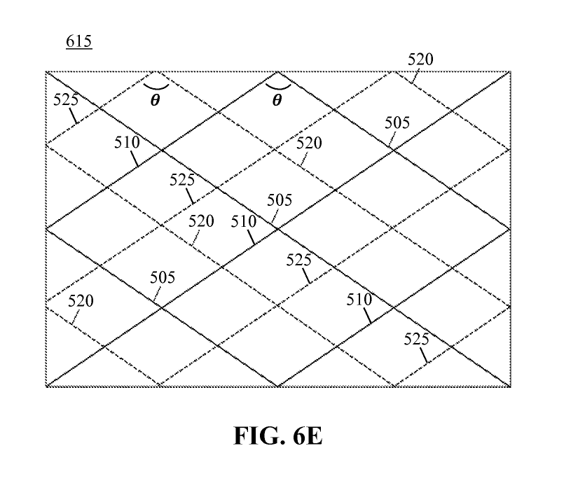

FIG. 6A shows a portion 605 of a first plurality of representations of parallel conductive lines oriented in a second direction 510 of a representation of a first conductive pattern (e.g., representation of 420 of FIG. 4) in accordance with one or more embodiments of the present invention. The representation of the first conductive pattern may be formed by placing a first plurality of representations of parallel conductive lines oriented in the second direction 510 having fixed trace width, T_{w}, and fixed pitch spacing, Pₛ, between adjacent representations of parallel conductive lines oriented in the second direction 510. The trace width, T_{w}, also referred to as the line width, refers to the width of a given representation of a parallel conductive line oriented in the second direction 510. The pitch spacing, Pₛ, refers to the spacing between adjacent representations of parallel conductive lines oriented in the second direction 510.

Continuing in FIG. 6B, a portion 605 of a first plurality of representations of parallel conductive lines oriented in a first direction 505 of the representation of the first conductive pattern (e.g., representation of 420 of FIG. 4) is shown in accordance with one or more embodiments of the present invention. The representation of the first conductive pattern may be further formed by placing a first plurality of representations of parallel conductive lines oriented in the first direction 505 having fixed trace width, T_{w}, and fixed pitch spacing, Pₛ, between adjacent representations of parallel conductive lines oriented in the first direction 505. As shown in FIG. 6B, the representations of parallel conductive lines oriented in the first direction 505 and the representations of parallel conductive lines oriented in the second direction 510 form a mesh. The relative angle, θ, between a given representation of a parallel conductive line oriented in the first direction 505 and an intersecting representation of a parallel conductive line oriented in the second direction 510 may vary based on an application or design. In certain embodiments, the relative angle, θ, may be 90 degrees, forming a rectangle-type mesh (not shown). In other embodiments, the relative angle, θ, may be greater than 90 degrees, forming a parallelogram-type mesh as shown in FIG. 6B. In still other embodiments, the relative angle, θ, may be less than 90 degrees, also forming a parallelogram-type mesh (not shown). While FIG. 6B shows a zoomed in view of the representation of the first conductive pattern, one of ordinary skill in the art will recognize that the same trace width, T_{w}, pitch spacing, Pₛ and relative angle, θ, may be used throughout the metal mesh area of the first conductive pattern (e.g., 420 of FIG. 4) of a conventional metal mesh touch sensor. One of ordinary skill in the art will also recognize that the order in which the first plurality of representations of parallel conductive lines oriented in the first direction 505 and the first plurality of representations of parallel conductive lines oriented in the second direction 510 are placed may vary in accordance with one or more embodiments of the present invention.

Continuing in FIG. 6C, a portion 610 of a second plurality of representations of parallel conductive lines oriented in a second direction 525 of a representation of a second conductive pattern (e.g., representation of 430 of FIG. 4) is shown in accordance with one or more embodiments of the present invention. The representation of the second conductive pattern may be formed by placing a second plurality of representations of parallel conductive lines oriented in the second direction 525 having fixed trace width, T_{w}, and fixed pitch spacing, Pₛ between adjacent representations of parallel conductive lines oriented in the second direction 525.

Continuing in FIG. 6D, a portion 610 of a second plurality of representations of parallel conductive lines oriented in a first direction 520 of the representation of the second conductive pattern (e.g., representation of 430 of FIG. 4) is shown in accordance with one or more embodiments of the present invention. The representation of the second conductive pattern may be further formed by placing a second plurality of representations of parallel conductive lines oriented in the first direction 520 having fixed trace width, T_{w}, and fixed pitch spacing, Pₛ between adjacent representations of parallel conductive lines oriented in the first direction 520. As shown in FIG. 6D, the representations of parallel conductive lines oriented in the first direction 520 and the representations of parallel conductive lines oriented in the second direction 525 form a mesh. The relative angle, θ, between a given representation of a parallel conductive line oriented in the first direction 520 and an intersecting representation of a parallel conductive line oriented in the second direction 525 may vary based on an application or design. In certain embodiments, the relative angle, θ, may be 90 degrees, forming a rectangle-type mesh (not shown). In other embodiments, the relative angle, θ, may be greater than 90 degrees, forming a parallelogram-type mesh as shown in FIG. 6D. In still other embodiments, the relative angle, θ, may be less than 90 degrees, also forming a parallelogram-type mesh (not shown). While FIG. 6D shows a zoomed in view of the representation of the second conductive pattern, one of ordinary skill in the art will recognize that the same trace width, T_{w}, pitch spacing, Pₛ and relative angle, θ, may be used throughout the metal mesh area of the second conductive pattern (e.g., 430 of FIG. 4) of a conventional metal mesh touch sensor. One of ordinary skill in the art will also recognize that the order in which the second plurality of representations of parallel conductive lines oriented in the first direction 520 and the second plurality of representations of parallel conductive lines oriented in the second direction 525 may vary in accordance with one or more embodiments of the present invention.

Continuing in FIG. 6E, a portion 615 of a metal mesh touch sensor (e.g., 130 of FIG. 1) is shown in accordance with one or more embodiments of the present invention. Once fabricated, the first conductive pattern (e.g., 420 of FIG. 4) and the second conductive pattern (e.g., 430 of FIG. 4) may be disposed on opposing sides of the same transparent substrate (e.g., transparent substrate 410) or the first conductive pattern may be disposed on a side of a first transparent substrate (e.g., transparent substrate 410), the second conductive pattern may be disposed on a side of a second transparent substrate (e.g., transparent substrate 410), and the substrates may be bonded together. As shown in FIG. 6E, the representation of the first conductive pattern and the representation of the second conductive pattern may be offset from one another in a manner that may vary based on an application or design. The offset may be one or more of a vertical, horizontal, and/or angular offset. In the embodiment depicted in FIG. 6E, the representation of the first conductive pattern and the representation of the second conductive pattern have the same trace width, T_{w}, the same pitch spacing, Pₛ the same relative angle, θ, and are substantially similar to one another in the patterns of the mesh, but are simply offset from one another.

In touch sensor applications, a touch sensor (e.g., 130 of FIG. 1) should not significantly impede the transmission of the image (not shown) of the underlying display device (e.g., 110 of FIG. 1) or otherwise draw attention to the touch sensor itself. As such, great care must be taken in the design of a touch sensor comprised of non-transparent conductors so that it is not readily apparent to an end user under normal operating conditions. However, a touch sensor comprised of non-transparent conductors may be somewhat visible for a variety of reasons. Despite best efforts to reduce the visibility of a given conductive pattern by, for example, size, shape, stack up, and/or design of the conductive pattern, when one or more conductive patterns overlay one another, such as, for example, in a touch sensor embodiment where conductive patterns (e.g., 420, 430 of FIG. 4) may be disposed on opposing sides of a transparent substrate (e.g., 410 of FIG. 4), the one or more overlapping conductive patterns are periodic and offset from one another in a manner that generates Moiré interference (not shown) that draws the user's eye to the one or more conductive patterns and renders the touch sensor itself more visibly apparent.

Moiré interference is the perception of patterns caused by overlapping images, where the patterns perceived are not part of the images themselves. Moiré interference is typically generated when identical or near identical patterns, such as conductive patterns of a touch sensor, are overlaid and displaced or rotated relative to one another. As noted above, touch sensors commonly employ conductive patterns that are periodic, substantially similar to one another in design, disposed on opposing sides of a transparent substrate or substrates, and offset from one another, making them prone to the generation of Moiré interference. In touch sensor applications, the pixel array structure of the underlying display device and the placement of the touch sensor relevant to the pixel array structure may also contribute to the generation of Moiré interference. When the conductive patterns of the touch sensor are periodic and uniform, the probability of the pixel array structure lining up just right with some part of the touch sensor, thereby generating Moiré interference, is substantial. Depending on the spacing between conductors, Moiré interference may be visible not only when the underlying display device is turned on and is transmitting an image through the touch sensor, but may be visible when the underlying display device is turned off in a reflective mode. As such, while efforts to reduce the visibility of the conductive patterns themselves are helpful, they do not address the issue of Moiré interference and the degradation of visual quality that accompanies it in touch sensor applications.

Accordingly, in one or more embodiments of the present invention, a metal mesh touch sensor with randomized pitch reduces or eliminates Moiré interference which substantially reduces or eliminates the visibility of a conductive pattern or patterns and a touch sensor in which they may be disposed.

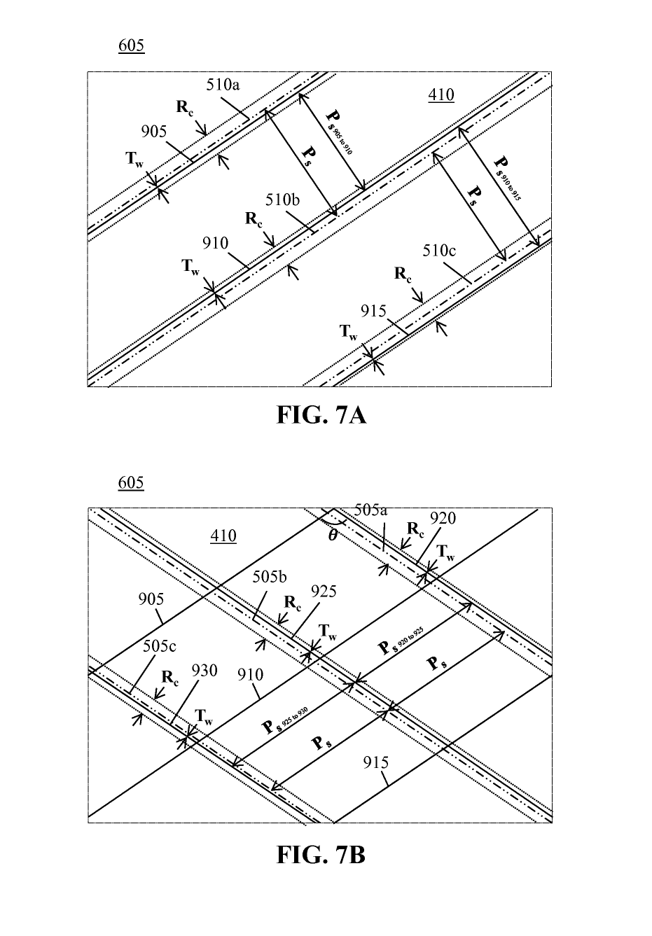

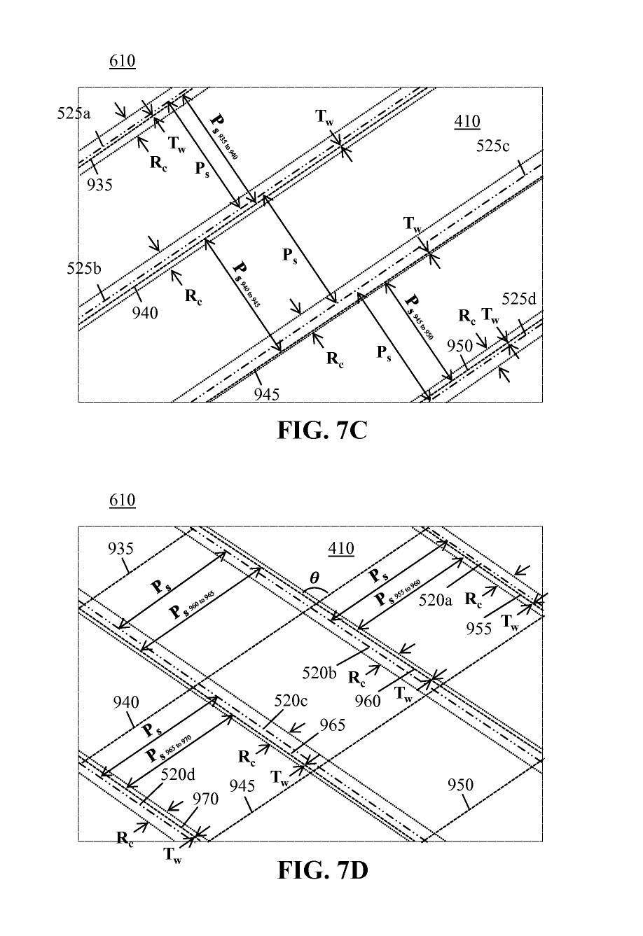

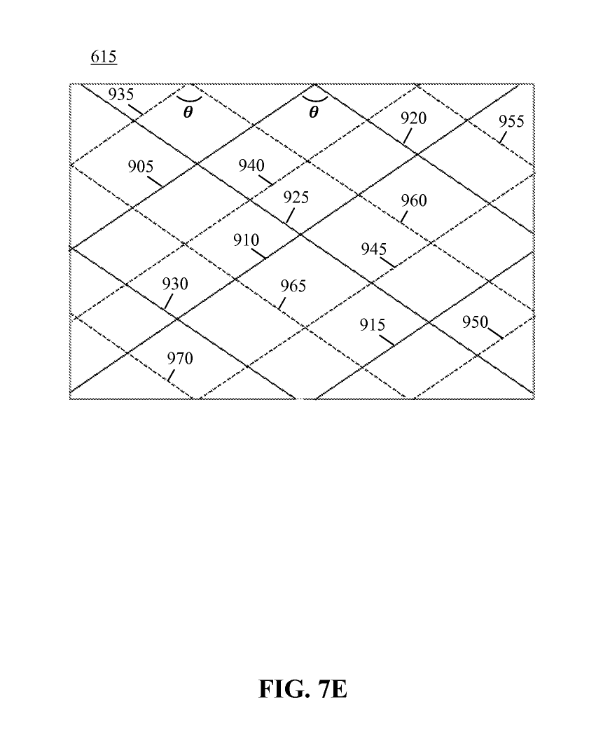

FIG. 7A shows a portion 605 of a first plurality of representations of parallel conductive lines oriented in a second direction (e.g., 905, 910, and 915) of a representation of a first conductive pattern (e.g., representation of 420 of FIG. 4) with randomized pitch in accordance with one or more embodiments of the present invention. The representation of the first conductive pattern may include the first plurality of representations of parallel conductive lines oriented in the second direction (e.g., 905, 910, and 915) with fixed trace width, T_{w}, and random pitch spacing between adjacent representations of parallel conductive lines. For example, random pitch spacing, Pₛ₉₀₅ₜₒ₉₁₀, between adjacent representations of parallel conductive lines 905 and 910 and random pitch spacing, Pₛ₉₁₀ₜₒ₉₁₅, between adjacent representations of parallel conductive lines 910 and 915. Because each representation of a parallel conductive line oriented in the second direction is displaced by a random offset, the representation of the first conductive pattern exhibits randomized pitch spacing.

The representation of the first conductive pattern may be formed by placing the first plurality of representations of parallel conductive lines oriented in the second direction in starting, or placeholder, locations (e.g., 510a, 510b, and 510c) with fixed trace width, T_{w}, and fixed pitch spacing, Pₛ, between adjacent representations of parallel conductive lines as, for example, shown in FIG. 6A. For each placed representation of a parallel conductive line oriented in the second direction (e.g., those at starting locations 510a, 510b, and 510c), a random offset may be generated within a randomization constraint, R_{c}. Each placed representation of a parallel conductive line oriented in the second direction may be moved from its own starting location (e.g., 510a, 510b, and 510c) in an amount dictated by its own randomly generated offset to its own final location (e.g., 905, 910, and 915), thereby giving rise to a randomized pitch.

The amount of random offset permissible may be constrained by the randomization constraint, R_{c}, which represents a virtual boundary, shown in the figure for purposes of illustration only, that is centered on and parallel to a given starting location. While a large randomization constraint, R_{c}, may reduce Moiré interference, the visibility of the constituent conductive lines may increase if the randomization constraint, R_{c}, is too large for a given application or design. To that end, in certain embodiments, the randomization constraint, R_{c}, may be in a range between +/−1 micrometer and +/−100 micrometers, where a randomization constraint, R_{c}, of, for example, +/−100 micrometers means a virtual boundary that extends 50 micrometers on either side of a given starting location as measured in a perpendicular manner. In other embodiments, the randomization constraint, R_{c}, may be in a range between +/−1 micrometer and +/−50 micrometers. In still other embodiments, the randomization constraint, R_{c}, may be in a range between +/−1 micrometer and +/−25 micrometers. However, other randomization constraint, R_{c}, ranges may be indicated or even dictated by a given application or design. As such, one of ordinary skill in the art will recognize that the randomization constraint, R_{c}, may vary in other ways in accordance with one or more embodiments of the present invention.

Random offsets may be viewed as positive or negative displacement, in a perpendicular manner, from the starting locations (e.g., 510a, 510b, and 510c) where representations of parallel conductive lines would be located in a representation of a first conductive pattern with fixed pitch spacing, Pₛ. In certain embodiments, a random offset, Rₒ, may be generated for a given placed representation by multiplying the randomization constraint, R_{c}, by the quantity (Rₙ−0.5), where Rₙ is a random number in a range between 0 and 1 inclusive that averages to 0.5 in the long run, e.g., Rₒ=R_{c}*(Rₙ−0.5) where 0≦Rₙ≦1. One of ordinary skill in the art will recognize that a random number Rₙ may be generated using conventional methods of generating a random number. One of ordinary skill in the art will also recognize that, while conventional methods of generating random numbers with computers are not truly random, they may be generated in a manner that is sufficiently random for the purpose of generating random offsets for use in one or more embodiments of the present invention. In other embodiments, a random offset, Rₒ, may be generated for a given starting location by generating a random number within the randomization constraint, R_{c}. In still other embodiments, a random offset, Rₒ, may be any random number, Rₙ, corresponding to displacement within the randomization constraint, R_{c}. One of ordinary skill in the art will recognize that other methods of generating random offsets, Rₒ, may be used in accordance with one or more embodiments of the present invention. One of ordinary skill in the art will also recognize that the method of generating random offsets, Rₒ, may vary based on an application or design in accordance with one or more embodiments of the present invention.

To generate the depicted portion of the representation of the first conductive pattern shown in FIG. 7A, a random offset may be generated for each starting location 510a, 510b, and 510c where a representation of a parallel conductive line oriented in the second direction would be disposed in a fixed pitch spacing, Pₛ, embodiment and the random offsets may be applied to move the placed representations in the starting locations to the final locations of the placed representations of parallel conductive lines oriented in the second direction 905, 910, and 915. Because a random offset is generated for each placed representation of a parallel conductive line oriented in the second direction, the pitch spacing from line-to-line is randomized while maintaining the general shape and characteristic of the mesh. For example, pitch spacing Pₛ₉₀₅ₜₒ₉₁₀ reflects a pitch spacing that is smaller than the pitch spacing, Pₛ, of a conventional fixed pitch spacing embodiment and pitch spacing Pₛ₉₁₀ₜₒ₉₁₅ reflects a pitch spacing that is larger than the pitch spacing, Pₛ, of a conventional fixed pitch spacing embodiment, but not the same as Pₛ₉₀₅ₜₒ₉₁₀.

Continuing in FIG. 7B, a portion 605 of a first plurality of representations of parallel conductive lines oriented in a first direction (e.g., 920, 925, and 930) of the representation of the first conductive pattern (e.g., representation of 420 of FIG. 4) with randomized pitch is shown in accordance with one or more embodiments of the present invention. The representation of the first conductive pattern may also include the first plurality of representations of parallel conductive lines oriented in the first direction (e.g., 920, 925, and 930) with fixed trace width, T_{w}, and random pitch spacing between adjacent representations of parallel conductive lines. For example, random pitch spacing Pₛ₉₂₀ₜₒ₉₂₅ between adjacent representations of parallel conductive lines 920 and 925 and random pitch spacing Pₛ₉₂₅ₜ₀₉₃₀ between adjacent representations of parallel conductive lines 925 and 930. Because each representation of a parallel conductive line oriented in the first direction is displaced by a random offset, the representation of the first conductive pattern exhibits randomized pitch spacing.

The representation of the first conductive pattern may be formed by placing the first plurality of representations of parallel conductive lines oriented in the first direction in starting, or placeholder, locations (e.g., 505a, 505b, and 505c) with fixed trace width, T_{w}, and fixed pitch spacing, Pₛ, between adjacent representations of parallel conductive lines as, for example, shown in FIG. 6B. For each placed representation of a parallel conductive line oriented in the second direction (e.g., those at starting locations 505a, 505b, and 505c), a random offset may be generated within a randomization constraint, R_{c}. Each placed representation of a parallel conductive line oriented in the first direction may be moved from its own starting location (e.g., 505a, 505b, and 505c) in an amount dictated by its own randomly generated offset to its own final location (e.g., 920, 925, and 930), thereby giving rise to randomized pitch.

The amount of random offset permissible may be constrained by the randomization constraint, R_{c}, which represents a virtual boundary, shown in the figure for purposes of illustration only, that is centered on and parallel to a given starting location. While a large randomization constraint, R_{c}, and correspondingly large variability in pitch, may reduce Moiré interference, the visibility of the constituent conductive lines may increase if the randomization constraint, R_{c}, is too large for a given application or design. To that end, in certain embodiments, the randomization constraint, R_{c}, may be in a range between +/−1 micrometer and +/−100 micrometers, where a randomization constraint, R_{c}, of, for example, +/−100 micrometers means a virtual boundary that extends 50 micrometers on either side of a given starting location as measured in a perpendicular manner. In other embodiments, the randomization constraint, R_{c}, may be in a range between +/−1 micrometer and +/−50 micrometers. In still other embodiments, the randomization constraint, R_{c}, may be in a range between +/−1 micrometer and +/−25 micrometers. However, other randomization constraint, R_{c}, ranges may be indicated or even dictated by a given application or design. As such, one of ordinary skill in the art will recognize that the randomization constraint, R_{c}, may vary in other ways in accordance with one or more embodiments of the present invention.

Random offsets may be viewed as positive or negative displacement, in a perpendicular manner, from the starting locations (e.g., 505a, 505b, and 505c) where representations of parallel conductive lines would be located in a representation of a first conductive pattern with fixed pitch spacing, Pₛ. In certain embodiments, a random offset, Rₒ, may be generated for a given placed representation by multiplying the randomization constraint, R_{c}, by the quantity (Rₙ−0.5), where Rₙ is a random number in a range between 0 and 1 inclusive that averages to 0.5 in the long run, e.g., Rₒ=R_{c}*(Rₙ−0.5) where 0≦Rₙ≦1. One of ordinary skill in the art will recognize that a random number Rₙ may be generated using conventional methods of generating a random number. One of ordinary skill in the art will also recognize that, while conventional methods of generating random numbers with computers are not truly random, they may be generated in a manner that is sufficiently random for the purpose of generating random offsets for use in one or more embodiments of the present invention. In other embodiments, a random offset, Rₒ, may be generated for a given starting location by generating a random number within the randomization constraint, R_{c}. In still other embodiments, a random offset, Rₒ, may be any random number, Rₙ, corresponding to displacement within the randomization constraint, R_{c}. One of ordinary skill in the art will recognize that other methods of generating random offsets, Rₒ, may be used in accordance with one or more embodiments of the present invention. One of ordinary skill in the art will also recognize that the method of generating random offsets, Rₒ, may vary based on an application or design in accordance with one or more embodiments of the present invention.

To generate the depicted portion of the representation of the first conductive pattern shown in FIG. 7B, a random offset may be generated for each starting location 505a, 505b, and 505c where a representation of a parallel conductive line oriented in the second direction would be disposed in a fixed pitch spacing, Pₛ embodiment and the random offsets may be applied to move the placed representations in the starting locations to the final locations of the placed representations of parallel conductive lines oriented in the first direction 920, 925, and 930. Because a random offset is generated for each placed representation of a parallel conductive line oriented in the first direction, the pitch spacing from line-to-line is randomized while maintaining the general shape and characteristic of the mesh. For example, pitch spacing Pₛ₉₂₀ₜₒ₉₂₅ reflects a pitch spacing that is slightly larger than the pitch spacing, Pₛ, of a conventional fixed pitch spacing embodiment. Similarly, pitch spacing Pₛ₉₂₅ₜₒ₉₃₀ reflects a pitch spacing that is larger than the pitch spacing, Pₛ, of a conventional fixed pitch spacing embodiment, but not the same as pitch spacing Pₛ₉₂₀ₜₒ₉₂₅.

The relative angle, θ, between the parallel conductive lines oriented in the first direction (e.g., 920, 925, and 930) and the parallel conductive lines oriented in the second direction (e.g., 905, 910, and 915) may vary based on an application or design. In certain embodiments, the relative angle, θ, may be 90 degrees, forming a rectangle-type mesh (not shown). In other embodiments, the relative angle, θ, may be greater than 90 degrees, forming a parallelogram-type mesh as shown in FIG. 7B. In still other embodiments, the relative angle, θ, may be less than 90 degrees, also forming a parallelogram-type mesh (not shown). While FIG. 7B shows a zoomed in view of the representation of the first conductive pattern (e.g., representation of 420 of FIG. 4), one of ordinary skill in the art will recognize that the same trace width, T_{w}, randomized line-to-line pitch spacing, Pₛ and relative angle, θ, may be applied throughout the metal mesh area of the first conductive pattern (e.g., 420 of FIG. 4) in accordance with one or more embodiments of the present invention.

Continuing in FIG. 7C, a portion 610 of a second plurality of representations of parallel conductive lines oriented in a second direction (e.g., 935, 940, 945, and 950) of a representation of a second conductive pattern (e.g., representation of 430 of FIG. 4) with randomized pitch is shown in accordance with one or more embodiments of the present invention. The representation of the second conductive pattern may include the second plurality of representations of parallel conductive lines oriented in the second direction (e.g., 935, 940, 945, and 950) with fixed trace width, T_{w}, and random pitch spacing between adjacent representations of parallel conductive lines. For example, random pitch spacing Pₛ₉₃₅ₜₒ₉₄₀ between adjacent representations of parallel conductive lines 935 and 940, random pitch spacing Pₛ₉₄₀ₜₒ₉₄₅ between adjacent representations of parallel conductive lines 940 and 945, and random pitch spacing Pₛ₉₄₅ₜₒ₉₅₀ between adjacent representations of parallel conductive lines 945 and 950. Because each representation of a parallel conductive line oriented in the second direction is displaced by a random offset, the representation of the second conductive pattern exhibits randomized pitch spacing.

The representation of the second conductive pattern may be formed by placing the second plurality of representations of parallel conductive lines oriented in the second direction in starting, or placeholder, locations (e.g., 525a, 525b, 525c, and 525d) with fixed trace width, T_{w}, and fixed pitch spacing, Pₛ, between adjacent representations of parallel conductive lines as, for example, shown in FIG. 6C. For each placed representation of a parallel conductive line oriented in the second direction (e.g., those at starting locations 525a, 525b, 525c, and 525d), a random offset may be generated within a randomization constraint, R_{c}. Each placed representation of a parallel conductive line oriented in the second direction may be moved from its own starting location (e.g., 525a, 525b, 525c, and 525d) in an amount dictated by its own randomly generated offset to its own final location (e.g., 935, 940, 945, and 950), thereby giving rise to a randomized pitch.

The amount of random offset permissible may be constrained by the randomization constraint, R_{c}, which represents a virtual boundary, shown in the figure for purposes of illustration only, that is centered on and parallel to a given starting location. While a large randomization constraint, R_{c}, and correspondingly large variability in pitch, may reduce Moiré interference, the visibility of the constituent conductive lines may increase if the randomization constraint, R_{c}, is too large for a given application or design. To that end, in certain embodiments, the randomization constraint, R_{c}, may be in a range between +/−1 micrometer and +/−100 micrometers, where a randomization constraint, R_{c}, of, for example, +/−100 micrometers means a virtual boundary that extends 50 micrometers on either side of a given starting location as measured in a perpendicular manner. In other embodiments, the randomization constraint, R_{c}, may be in a range between +/−1 micrometer and +/−50 micrometers. In still other embodiments, the randomization constraint, R_{c}, may be in a range between +/−1 micrometer and +/−25 micrometers. However, other randomization constraint, R_{c}, ranges may be indicated or even dictated by a given application or design. As such, one of ordinary skill in the art will recognize that the randomization constraint, R_{c}, may vary in other ways in accordance with one or more embodiments of the present invention.

Random offsets may be viewed as positive or negative displacement, in a perpendicular manner, from the starting locations (e.g., 525a, 525b, 525c, and 525d) where representations of parallel conductive lines would be located in a representation of a second conductive pattern with fixed pitch spacing, Pₛ. In certain embodiments, a random offset, Rₒ, may be generated for a given placed representation by multiplying the randomization constraint, R_{c}, by the quantity (Rₙ−0.5), where Rₙ is a random number in a range between 0 and 1 inclusive that averages to 0.5 in the long run, e.g., Rₒ=R_{c}*(Rₙ−0.5) where 0≦Rₙ≦1. One of ordinary skill in the art will recognize that a random number Rₙ may be generated using conventional methods of generating a random number. One of ordinary skill in the art will also recognize that, while conventional methods of generating random numbers with computers are not truly random, they may be generated in a manner that is sufficiently random for the purpose of generating random offsets for use in one or more embodiments of the present invention. In other embodiments, a random offset, Rₒ, may be generated for a given starting location by generating a random number within the randomization constraint, R_{c}. In other embodiments, Rₒ may be any random number, Rₙ, corresponding to displacement within the randomization constraint, R_{c}. One of ordinary skill in the art will recognize that other methods of generating random offsets, Rₒ, may be used in accordance with one or more embodiments of the present invention. One of ordinary skill in the art will also recognize that the method of generating random offsets, Rₒ, may vary based on an application or design in accordance with one or more embodiments of the present invention.

To generate the depicted portion of the representation of the second conductive pattern shown in FIG. 7C, a random offset may be generated for each starting location 525a, 525b, 525c, and 525d where a representation of a parallel conductive line oriented in the second direction would be disposed in a fixed pitch spacing, Pₛ, embodiment and the random offsets may be applied to move the placed representations in the starting locations to the final locations of the placed representations of parallel conductive lines oriented in the second direction 935, 940, 945, and 950. Because a random offset is generated for each placed representation of a parallel conductive line oriented in the second direction, the pitch spacing from line-to-line is randomized while maintaining the general shape and characteristic of the mesh. For example, pitch spacing Pₛ₉₃₅ₜₒ₉₄₀ reflects a pitch spacing that is larger than the pitch spacing, Pₛ, of a conventional fixed pitch spacing embodiment, pitch spacing Pₛ₉₄₀ₜₒ₉₄₅ reflects a pitch spacing that is larger than the pitch spacing, Pₛ, of a conventional fixed pitch spacing embodiment, but not the same as Pₛ₉₃₅ₜₒ₉₄₀, and pitch spacing Pₛ₉₄₅ₜₒ₉₅₀ reflects a pitch spacing that is larger than the pitch spacing, Pₛ, of a conventional fixed pitch spacing embodiment, but not the same as Pₛ₉₃₅ₜₒ₉₄₀ or Pₛ₉₄₀ₜₒ₉₄₅.

Continuing in FIG. 7D, a portion 610 of a second plurality of parallel conductive lines oriented in a first direction (e.g., 955, 960, 965, and 970) of a representation of the second conductive pattern (e.g., representation of 430 of FIG. 4) with randomized pitch is shown in accordance with one or more embodiments of the present invention. The representation of the second conductive pattern may also include the second plurality of representations of parallel conductive lines oriented in the first direction (e.g., 955, 960, 965, and 970) with fixed trace width, T_{w}, and random pitch spacing between adjacent representations of parallel conductive lines. For example, random pitch spacing Pₛ₉₅₅ₜₒ₉₆₀ between adjacent representations of parallel conductive lines 955 and 960, random pitch spacing Pₛ₉₆₀ₜₒ₉₆₅ between adjacent representations of parallel conductive lines 960 and 965, and random pitch spacing Pₛ₉₆₅ₜₒ₉₇₀ between adjacent representations of parallel conductive lines 965 and 970. Because each representation of a parallel conductive line oriented in the first direction is displaced by a random offset, the representation of the second conductive pattern exhibits randomized pitch spacing.

The representation of the second conductive pattern may be formed by placing the second plurality of representations of parallel conductive lines oriented in the first direction in starting, or placeholder, locations (e.g., 520a, 520b, 520c, and 520d) with fixed trace width, T_{w}, and fixed pitch spacing, Pₛ, between adjacent representations of parallel conductive lines as, for example, shown in FIG. 6D. For each placed representation of a parallel conductive line oriented in the second direction (e.g., those at starting locations 520a, 520b, 520c, and 520d), a random offset may be generated within a randomization constraint, R_{c}. Each placed representation of a parallel conductive line oriented in the first direction may be moved from its own starting location (e.g., 520a, 520b, 520c, and 520d) in an amount dictated by its own randomly generated offset to its own final location (e.g., 955, 960, 965, and 970), thereby giving rise to randomized pitch.

The amount of random offset permissible may be constrained by the randomization constraint, R_{c}, which represents a virtual boundary, shown in the figure for purposes of illustration only, that is centered on and parallel to a given starting location. While a large randomization constraint, R_{c}, and correspondingly large variability in pitch, may reduce Moiré interference, the visibility of the constituent conductive lines may increase if the randomization constraint, R_{c}, is too large for a given application or design. To that end, in certain embodiments, the randomization constraint, R_{c}, may be in a range between +/−1 micrometer and +/−100 micrometers, where a randomization constraint, R_{c}, of, for example, +/−100 micrometers means a virtual boundary that extends 50 micrometers on either side of a given starting location as measured in a perpendicular manner. In other embodiments, the randomization constraint, R_{c}, may be in a range between +/−1 micrometer and +/−50 micrometers. In still other embodiments, the randomization constraint, R_{c}, may be in a range between +/−1 micrometer and +/−25 micrometers. However, other randomization constraint, R_{c}, ranges may be indicated or even dictated by a given application or design. As such, one of ordinary skill in the art will recognize that the randomization constraint, R_{c}, may vary in other ways in accordance with one or more embodiments of the present invention.

Random offsets may be viewed as positive or negative displacement, in a perpendicular manner, from the starting locations (e.g., 520a, 520b, 520c, and 520d) where representations of parallel conductive lines would be located in a representation of a second conductive pattern with fixed pitch spacing, Pₛ. In certain embodiments, a random offset, Rₒ, may be generated for a given placed representation by multiplying the randomization constraint, R_{c}, by the quantity (Rₙ−0.5), where Rₙ is a random number in a range between 0 and 1 inclusive that averages to 0.5 in the long run, e.g., Rₒ=R_{c}*(Rₙ−0.5) where 0≦Rₙ≦1. One of ordinary skill in the art will recognize that a random number Rₙ may be generated using conventional methods of generating a random number. One of ordinary skill in the art will also recognize that, while conventional methods of generating random numbers with computers are not truly random, they may be generated in a manner that is sufficiently random for the purpose of generating random offsets for use in one or more embodiments of the present invention. In other embodiments, a random offset, Rₒ, may be generated for a given starting location by generating a random number within the randomization constraint, R_{c}. In still other embodiments, a random offset, Rₒ may be any random number, Rₙ, corresponding to displacement within the randomization constraint, R_{c}. One of ordinary skill in the art will recognize that other methods of generating random offsets, Rₒ, may be used in accordance with one or more embodiments of the present invention. One of ordinary skill in the art will also recognize that the method of generating random offsets, Rₒ, may vary based on an application or design in accordance with one or more embodiments of the present invention.

To generate the depicted portion of the representation of the second conductive pattern shown in FIG. 7D, a random offset may be generated for each starting location 520a, 520b, 520c, and 520d where a representation of a parallel conductive line oriented in the second direction would be disposed in a fixed pitch spacing, Pₛ, embodiment and the random offsets may be applied to move the placed representations in the starting locations to the final locations of the placed representations of parallel conductive lines oriented in the first direction 955, 960, 965, and 970. Because a random offset is generated for each placed representation of a parallel conductive line oriented in the first direction, the pitch spacing from line-to-line is randomized while maintaining the general shape and characteristic of the mesh. For example, pitch spacing Pₛ₉₅₅ₜₒ₉₆₀ reflects a pitch spacing that is smaller than the pitch spacing, Pₛ, of a conventional fixed pitch spacing embodiment, pitch spacing Pₛ₉₆₀ₜₒ₉₆₅ reflects a pitch spacing that is larger than the pitch spacing, Pₛ, of a conventional fixed pitch spacing embodiment, but not the same as pitch spacing Pₛ₉₅₅ₜₒ₉₆₀, and pitch spacing Pₛ₉₆₅ₜₒ₉₇₀ reflects a pitch spacing that is larger than the pitch spacing, Pₛ, of a conventional fixed pitch spacing embodiment, but not the same as Pₛ₉₅₅ₜₒ₉₆₀ or Pₛ₉₆₀ₜₒ₉₆₅.

The relative angle, θ, between the parallel conductive lines oriented in the first direction (e.g., 935, 940, 945, and 950) and the parallel conductive lines oriented in the second direction (e.g., 955, 960, 965, and 970) may vary based on an application or design. In certain embodiments, the relative angle, θ, may be 90 degrees, forming a rectangle-type mesh (not shown). In other embodiments, the relative angle, θ, may be greater than 90 degrees, forming a parallelogram-type mesh as shown in FIG. 7D. In still other embodiments, the relative angle, θ, may be less than 90 degrees, also forming a parallelogram-type mesh (not shown). While FIG. 7D shows a zoomed in view of the representation of the second conductive pattern (e.g., representation of 430 of FIG. 4), one of ordinary skill in the art will recognize that the same trace width, T_{w}, randomized line-to-line pitch spacing, Pₛ and relative angle, θ, may be applied throughout the metal mesh area of the second conductive pattern (e.g., 430 of FIG. 4) in accordance with one or more embodiments of the present invention.

Continuing in FIG. 7E, a portion 615 of a metal mesh touch sensor (e.g., 130 of FIG. 1) with randomized pitch is shown in accordance with one or more embodiments of the present invention. Once fabricated, the first conductive pattern (e.g., 420 of FIG. 4) and the second conductive pattern (e.g., 430 of FIG. 4) may be disposed on opposing sides of the same transparent substrate (e.g., transparent substrate 410) or the first conductive pattern may be disposed on a side of a transparent substrate (e.g., transparent substrate 410), the second conductive pattern may be disposed on a side of another transparent substrate (e.g., transparent substrate 410), and the substrates may be bonded together. As discussed above and shown in FIG. 7E, the representation of the first conductive pattern and the representation of the second conductive pattern may be offset from one another in a manner that may vary based on an application or design. The offset may be one or more of a vertical, horizontal, and/or angular offset. In the embodiment depicted in FIG. 7E, the representation of the first conductive pattern and the representation of the second conductive pattern have the same trace width, T_{w}, randomized line-to-line pitch spacing, and the same relative angle, θ. Because of the randomized pitch, the pitch spacing from line-to-line is randomized while maintaining the general shape and characteristic of the mesh. As a consequence, each representation of a conductive pattern does not include repetitive patterns and the representations of the conductive patterns are not periodic or identical, even though they are very similar in shape. As shown in FIG. 7E, the size of the parallelogram shapes formed by the representations of the parallel conductive lines varies because of the randomized pitch. Because of the lack of similarity between the conductive patterns, they are not prone to generate Moiré interference.

In one or more embodiments of the present invention, a method of designing a metal mesh touch sensor with randomized pitch may include generating a representation of a first conductive pattern in a software application by placing a first plurality of representations of parallel conductive lines oriented in a first direction with random pitch spacing between adjacent representations of parallel conductive lines oriented in the first direction and placing a first plurality of representations of parallel conductive lines oriented in a second direction with random pitch spacing between adjacent representations of parallel conductive lines oriented in the second direction. One of ordinary skill in the art will recognize that the order of placement may vary based on an application or design.

In embodiments that use more than one conductive pattern, the method may also include generating a representation of a second conductive pattern in the software application by placing a second plurality of representations of parallel conductive lines oriented in a first direction with random pitch spacing between adjacent representations of parallel conductive lines oriented in the first direction and placing a second plurality of representations of parallel conductive lines oriented in a second direction with random pitch spacing between adjacent representations of parallel conductive lines oriented in the second direction. One of ordinary skill in the art will recognize that the order of placement may vary based on an application or design.

The method may also include placing a first plurality of representations of channel breaks that partition the representation of the first conductive pattern into a plurality of representations of column channels, placing a first plurality of representations of channel pads in connection to the plurality of representations of column channels, and placing a first plurality of representations of interconnect conductive lines that route the plurality of representations of column channels to a first plurality of representations of interface connectors.

In embodiments that use more than one conductive pattern, the method may also include placing a second plurality of representations of channel breaks that partition the representation of the second conductive pattern into a plurality of representations of row channels, placing a second plurality of representations of channel pads in connection to the plurality of representations of row channels, and placing a second plurality of representations of interconnect conductive lines that route the plurality of representations of row channels to a second plurality of representations of interface connectors. One of ordinary skill in the art will recognize that either the first or the second conductive pattern may be used to form column or row channels in accordance with one or more embodiments of the present invention.

In certain embodiments, each placed representation of a parallel conductive line in the representation of the first conductive pattern (mesh area) may have a line width less than 10 micrometers. In still other embodiments, each placed representation of a parallel conductive line in the representation of the first conductive pattern may have a line width greater than 10 micrometers.

In certain embodiments that use more than one conductive pattern, each placed representation of a parallel conductive line in the representation of the second conductive pattern (mesh area) may have a line width less than 10 micrometers. In still other embodiments, each placed representation of a parallel conductive line in the representation of the first conductive pattern may have a line width greater than 10 micrometers.

Advantages of one or more embodiments of the present invention may include one or more of the following:

In one or more embodiments of the present invention, a metal mesh touch sensor with randomized pitch reduces or eliminates Moiré interference.

In one or more embodiments of the present invention, a metal mesh touch sensor with randomized pitch does not negatively impact the transmittance of the image of the underlying display device and does not draw the eye to the one or more conductive patterns of the touch sensor.

In one or more embodiments of the present invention, a metal mesh touch sensor with randomized pitch provides the same or substantially the same amount of macro light transmittance as compared to a non-randomized metal mesh touch sensor.

In one or more embodiments of the present invention, a metal mesh touch sensor with randomized pitch provides the same or substantially the same amount of haze as comparted to a non-randomized metal mesh touch sensor.

In one or more embodiments of the present invention, a metal mesh touch sensor with randomized pitch reduces or eliminates issues with registration when a multi-station flexographic printing system is used to print a catalytic ink image of a metal mesh touch sensor with randomized pitch as part of the fabrication of the touch sensor. In this way, errors in registration between flexographic printing stations that additively print one or more catalytic ink images of the conductive patterns on one or more substrates may merely further randomization efforts.

In one or more embodiments of the present invention, a metal mesh touch sensor with randomized pitch may be compatible with any process suitable for designing and/or fabricating non-transparent conductive patterns on a transparent substrate.

In one or more embodiments of the present invention, a metal mesh touch sensor with randomized pitch may be designed using existing software applications. For example, one or more of the conductive patterns having conductive lines with randomized pitch may be designed in the same CAD software application used to design a conductive pattern of a conventional metal mesh touch sensor.

In one or more embodiments of the present invention, a metal mesh touch sensor with randomized pitch may be fabricated using existing fabrication methods. For example, a flexographic printing process may be used to print a catalytic ink image of one or more conductive patterns on a transparent substrate that are metallized by an electroless plating process to produce one or more conductive patterns on substrate.

In one or more embodiments of the present invention, a metal mesh touch sensor with randomized pitch reduces the effects of pixelization when writing an image of a conductive pattern with randomized pitch on a thermal imaging layer using a laser beam as part of the process of fabricating a flexographic printing plate.

In one or more embodiments of the present invention, a metal mesh touch sensor with randomized pitch does not increase the material cost of fabrication over a conventional metal mesh touch sensor.

In one or more embodiments of the present invention, a metal mesh touch sensor with randomized pitch does not increase the time of fabrication over a conventional metal mesh touch sensor.

In one or more embodiments of the present invention, a metal mesh touch sensor with randomized pitch does not increase the complexity of fabrication over a conventional metal mesh touch sensor.

While the present invention has been described with respect to the above-noted embodiments, those skilled in the art, having the benefit of this disclosure, will recognize that other embodiments may be devised that are within the scope of the invention as disclosed herein. Accordingly, the scope of the invention should be limited only by the appended claims.

What is claimed is:

1. A method of designing a metal mesh touch sensor with randomized pitch comprising:
placing a first plurality of representations of parallel conductive lines oriented in a first direction with fixed pitch spacing between adjacent representations of parallel conductive lines oriented in the first direction;
for each placed representation of a parallel conductive line in the first plurality of representations of parallel conductive lines oriented in the first direction, generating a first random offset amount within a predetermined randomization constraint and moving the placed representation of the parallel conductive line by the first random offset;
placing a first plurality of representations of parallel conductive lines oriented in a second direction with fixed pitch spacing between adjacent representations of parallel conductive lines oriented in the second direction; and
for each placed representation of a parallel conductive line in the first plurality of representations of parallel conductive lines oriented in the second direction, generating a second random offset amount within the predetermined randomization constraint and moving the placed representation of the parallel conductive line by the second random offset.

2. The method of claim 1, further comprising:
placing a second plurality of representations of parallel conductive lines oriented in a first direction with fixed pitch spacing between adjacent representations of parallel conductive lines oriented in the first direction;
for each placed representation of a parallel conductive line in the second plurality of representations of parallel conductive lines oriented in the first direction, generating a third random offset amount within the predetermined randomization constraint and moving the placed representation of the parallel conductive line by the third random offset;
placing a second plurality of representations of parallel conductive lines oriented in a second direction with fixed pitch spacing between adjacent representations of parallel conductive lines oriented in the second direction; and
for each placed representation of a parallel conductive line in the second plurality of representations of parallel conductive lines oriented in the second direction, generating a fourth random offset amount within the predetermined randomization constraint and moving the placed representation of the parallel conductive line by the fourth random offset.

3. The method of claim 1, further comprising:
placing a first plurality of representations of channel breaks that partition a representation of the first conductive pattern into a plurality of representations of column channels;
placing a first plurality of representations of channel pads in connection to the plurality of representations of column channels; and
placing a first plurality of representations of interconnect conductive lines that route the plurality of representations of column channels to a first plurality of representations of interface connectors.

4. The method of claim 2, further comprising:
placing a second plurality of representations of channel breaks that partition a representation of the second conductive pattern into a plurality of representations of row channels;
placing a second plurality of representations of channel pads in connection to the plurality of representations of row channels; and
placing a second plurality of representations of interconnect conductive lines that route the plurality of representations of row channels to a second plurality of representations of interface connectors.

5. The method of claim 1, wherein the first plurality of representations of parallel conductive lines oriented in the first direction are perpendicular to the first plurality of representations of parallel conductive lines oriented in the second direction.

6. The method of claim 1, wherein the first plurality of representations of parallel conductive lines oriented in the first direction are angled relative to the first plurality of representations of parallel conductive lines oriented in the second direction.

7. The method of claim 2, wherein the second plurality of representations of parallel conductive lines oriented in the first direction are perpendicular to the second plurality of representations of parallel conductive lines oriented in the second direction.

8. The method of claim 2, wherein the second plurality of representations of parallel conductive lines oriented in the first direction are angled relative to the second plurality of representations of parallel conductive lines oriented in the second direction.

9. The method of claim 1, wherein each placed representation of a parallel conductive line in the representation of the first conductive pattern has a line width less than 10 micrometers.

10. The method of claim 2, wherein each placed representation of a parallel conductive line in the representation of the second conductive pattern has a line width less than 10 micrometers.

11. A metal mesh touch sensor with randomized pitch comprising:
a transparent substrate;
a first conductive pattern disposed on a first side of the transparent substrate, wherein the first conductive pattern comprises a first plurality of parallel conductive lines oriented in a first direction with randomized pitch spacing between adjacent parallel conductive lines oriented in the first direction and a first plurality of parallel conductive lines oriented in a second direction with randomized pitch spacing between adjacent parallel conductive lines oriented in the second direction; and
a second conductive pattern disposed on a second side of the transparent substrate, wherein the second conductive pattern comprises a second plurality of parallel conductive lines oriented in the first direction with randomized pitch spacing between adjacent parallel conductive lines oriented in the first direction and a second plurality of parallel conductive lines oriented in the second direction with randomized pitch spacing between adjacent parallel conductive lines oriented in the second direction.

12. The metal mesh touch sensor of claim 11, further comprising:
a first plurality of channel breaks that partition the first conductive pattern into a plurality of electrically isolated column channels;
a first plurality of channel pads in electrical connection with the corresponding plurality of column channels;
a first plurality of interconnect conductive lines that provide electrical connectivity between the first plurality of channel pads and a corresponding first plurality of interface connectors;
a second plurality of channel breaks that partition the second conductive pattern into a plurality of electrically isolated row channels;
a second plurality of channel pads in electrical connection with the corresponding plurality of row channels; and
a second plurality of interconnect conductive lines that provide electrical connectivity between the second plurality of channel pads and a corresponding second plurality of interface connectors.

13. The metal mesh touch sensor of claim 11, wherein the first plurality of parallel conductive lines oriented in the first direction are perpendicular to the first plurality of parallel conductive lines oriented in the second direction and the second plurality of parallel conductive lines oriented in the first direction are perpendicular to the second plurality of parallel conductive lines oriented in the second direction.

14. The metal mesh touch sensor of claim 11, wherein the first plurality of parallel conductive lines oriented in the first direction are angled relative to the first plurality of parallel conductive lines oriented in the second direction and the second plurality of parallel conductive lines oriented in the first direction are angled relative to the second plurality of parallel conductive lines oriented in the second direction.

15. The metal mesh touch sensor of claim 14, wherein the relative angle is in a range between 0 degrees and 90 degrees.

16. The metal mesh touch sensor of claim 14, wherein the relative angle is in a range between 90 degrees and 180 degrees.

17. The metal mesh touch sensor of claim 11, wherein each parallel conductive line has a line width less than 10 micrometers.

18. The metal mesh touch sensor of claim 11, wherein the transparent substrate comprises polyethylene terephthalate.

19. A metal mesh touch sensor with randomized pitch comprising:
a first transparent substrate;
a first conductive pattern disposed on a side of the first transparent substrate, wherein the first conductive pattern comprises a first plurality of parallel conductive lines oriented in a first direction with randomized pitch spacing between adjacent parallel conductive lines oriented in the first direction and a first plurality of parallel conductive lines oriented in a second direction with randomized pitch spacing between adjacent parallel conductive lines oriented in the second direction;
a second transparent substrate; and
a second conductive pattern disposed on a second side of the transparent substrate, wherein the second conductive pattern comprises a second plurality of parallel conductive lines oriented in the first direction with randomized pitch spacing between adjacent parallel conductive lines oriented in the first direction and a second plurality of parallel conductive lines oriented in the second direction with randomized pitch spacing between adjacent parallel conductive lines oriented in the second direction,
wherein the first transparent substrate is bonded to the second transparent substrate.

20. The metal mesh touch sensor of claim 19, further comprising:
a first plurality of channel breaks that partition the first conductive pattern into a plurality of electrically isolated column channels;
a first plurality of channel pads in electrical connection with the corresponding plurality of column channels;
a first plurality of interconnect conductive lines that provide electrical connectivity between the first plurality of channel pads and a corresponding first plurality of interface connectors;
a second plurality of channel breaks that partition the second conductive pattern into a plurality of electrically isolated row channels;
a second plurality of channel pads in electrical connection with the corresponding plurality of row channels; and
a second plurality of interconnect conductive lines that provide electrical connectivity between the second plurality of channel pads and a corresponding second plurality of interface connectors.

21. The metal mesh touch sensor of claim 19, wherein the first plurality of parallel conductive lines oriented in the first direction are perpendicular to the first plurality of parallel conductive lines oriented in the second direction and the second plurality of parallel conductive lines oriented in the first direction are perpendicular to the second plurality of parallel conductive lines oriented in the second direction.

22. The metal mesh touch sensor of claim 19, wherein the first plurality of parallel conductive lines oriented in the first direction are angled relative to the first plurality of parallel conductive lines oriented in the second direction and the second plurality of parallel conductive lines oriented in the first direction are angled relative to the second plurality of parallel conductive lines oriented in the second direction.

23. The metal mesh touch sensor of claim 22, wherein the relative angle is in a range between 0 degrees and 90 degrees.

24. The metal mesh touch sensor of claim 22, wherein the relative angle is in a range between 90 degrees and 180 degrees.

25. The metal mesh touch sensor of claim 19, wherein each parallel conductive line has a line width less than 10 micrometers.

26. The metal mesh touch sensor of claim 19, wherein the first and the second transparent substrate comprise polyethylene terephthalate.
